(19) United States
(12) Patent Application Publication
(10) Pub. No.: US 2026/0088666 A1
(43) Pub. Date: Mar. 26, 2026

(54) STATOR, ROTATING ELECTRIC MACHINE, AND METHOD FOR MANUFACTURING STATOR

(71) Applicant: HONDA MOTOR CO., LTD., Tokyo (JP)

(72) Inventors: Takuro YOSHIMURA, Tokyo (JP); Yoshiyuki IZUMI, Tokyo (JP); Kazuhito HIRAGA, Tokyo (JP)

(21) Appl. No.: 19/332,075

(22) Filed: Sep. 18, 2025

(30) Foreign Application Priority Data
Sep. 26, 2024 (JP) 2024-167180

(51) Int. Cl. H02K 1/16; H02K 3/12; H02K 3/30; H02K 3/34; H02K 15/026; H02K 15/106; H02K 15/22

(52) U.S. Cl. CPC H02K 1/165; H02K 3/12; H02K 3/30; H02K 3/345; H02K 15/026; H02K 15/106; H02K 15/22

(57) ABSTRACT

A stator including: a conductor disposed in a slot formed in a stator core; and an insulator disposed between the slot and the conductor, the stator including a coolant flow path through which a coolant flows between the slot and the conductor. The insulator includes a foam layer that foams when heated inside the slot. The foam layer includes: a foaming-function portion that fills a gap between the slot and the conductor by exhibiting a heat-induced foaming function; and a foaming-function reduction portion that is thinner than the foaming-function portion due to a reduction in the heat-induced foaming function of the foam layer, and that forms a gap between the slot and the conductor through which the coolant can flow.

This application is based on and claims the benefit of priority from Japanese Patent Application No. 2024-167180, filed on 26 Sep. 2024, the content of which is incorporated herein by reference.

### BACKGROUND OF THE INVENTION

### Field of the Invention

The present disclosure relates to a stator, a rotating electric machine, and a method for manufacturing a stator.

### Related Art

Conventionally, a stator is known in which a conductor is arranged and inserted into a slot of the stator of a rotating electric machine via an insulator. In such a configuration, a coolant flow path for cooling the conductor is formed between the conductor and the insulator. A surface of the insulator that faces the conductor includes a plurality of rows of foamed resin layers formed by heat-induced foaming a plurality of rows of strip-shaped foam adhesive. The coolant flow path is formed by gaps between the adjacent foamed resin layers (for example, see Japanese Unexamined Patent Application, Publication No. 2017-127063).
Patent Document 1: Japanese Unexamined Patent Application, Publication No. 2017-127063

### SUMMARY OF THE INVENTION

However, in the conventional technology, it is necessary to apply and form rows of the foam adhesive on a base material of the insulator, which makes the manufacturing process of the insulator complicated. Moreover, the arrangement of the coolant flow path differs depending on the type of the stator (such as the thickness of the stator core, the cross-sectional shape of the conductor, the number of rows of inserted conductors, and the size of the slot relative to the conductor). In cases where the stator type varies, the foam adhesive should be applied while changing the arrangement of the foam adhesive for each type. Therefore, the cost of the insulator increases, and the manufacturing cost of the stator becomes higher.

Accordingly, the present disclosure provides a stator including an insulator that allows coolant to flow between a conductor and a slot, and that can be easily and economically manufactured, as well as a rotating electric machine including such a stator, and a method for manufacturing such a stator.
(1) A stator (for example, the stator 3 described later) including: a conductor (for example, the conductors 8, 81, or 82 described later) disposed in a slot (for example, the slot 7 described later) formed in a stator core (for example, the stator core 6 described later); and an insulator (for example, the insulator 11 described later) disposed between the slot and the conductor, in which the stator includes a coolant flow path (for example, the second coolant flow path 21b described later) that allows a coolant (for example, the coolant CL described later) to flow between the slot and the conductor, in which the insulator includes a foam layer (for example, the foam layer 112 described later) configured to foam when heated inside the slot, and in which the foam layer includes: a foaming-function portion (for example, the foaming-function portion Fa described later) that fills a gap between the slot and the conductor by exhibiting a heat-induced foaming function; and a foaming-function reduction portion (for example, the foaming-function reduction portion Fb described later) that has a smaller thickness than the foaming-function portion due to a reduction in the heat-induced foaming function compared to the foaming-function portion, and that forms a gap between the slot and the conductor to allow the coolant to flow therethrough.

According to (1), it is possible to easily and economically manufacture a stator including an insulator through which a coolant can flow, merely by forming in a foam layer provided in the insulator: a foaming-function portion that fills a gap between a slot and a conductor, and a foaming-function reduction portion that is thinner than the foaming-function portion and that forms a gap between the slot and the conductor, the gap allowing the coolant to flow.
(2) In the stator as described in (1), the conductor includes: a normal shape portion (for example, the normal shape portions 8N, 81N, and 82N described later) in a region inserted into the slot; and a specific shape portion (for example, the specific shape portions 8S, 81S, and 82S described later) that has a conductor width that is partially thinner than that of the normal shape portion along a circumferential direction of the stator core, and that allows the coolant to flow in a radial direction of the stator core, in which the foaming-function reduction portion of the insulator is disposed in a region corresponding to the specific shape portion of the conductor.

According to (2), since the coolant can smoothly flow along the crushed portion of the conductor in the slot, the cooling performance of the conductor is improved.
(3) In the stator as described in (1) or (2), the slot includes a slit (for example, the slit 71 described later) that opens toward a central axial hole (for example, the central axial hole 61 described later) of the stator core, and the foaming-function portion of the insulator is disposed so as to close the slit.

According to (3), it is possible to effectively prevent the coolant that has flowed into the slot from leaking through the slit.
(4) A rotating electric machine (for example, the rotating electric machine 1 described later) including the stator (for example, the stator 3 described later) as described in any one of (1) to (3).

According to (4), it is possible to easily and economically manufacture a stator including an insulator through which a coolant can flow, merely by forming in a foam layer provided over the entire surface of the insulator: a foaming-function portion that fills a gap between a slot and a conductor, and a foaming-function reduction portion that is thinner than the foaming-function portion and that forms a gap between the slot and the conductor, the gap allowing the coolant to flow.
(5) A method for manufacturing a stator (for example, the stator 3 described later) including: a conductor (for example, the conductors 8, 81, or 82 described later) disposed in a slot (for example, the slot 7 described later) formed in a stator core (for example, the stator core 6 described later); and an insulator (for example, the insulator 11 described later) disposed between the slot and the conductor, in which the stator includes a coolant flow path (for example, the second coolant flow path 21b described later) that allows a coolant to flow between the slot and the conductor, in which the insulator includes a foam layer (for example, the foam layer 112 described later) configured to foam when heated inside the slot, the method including: locally heating, before inserting the insulator into the slot, a portion of the foam layer at a position where a gap allowing the coolant to flow between the conductor and the insulator is required, thereby foaming the portion of the foam layer; pressurizing the foamed region to reduce the heat-induced foaming function, thereby forming a foaming-function reduction portion (for example, the foaming-function reduction portion Fb described later) in the foam layer; inserting the insulator including the foaming-function reduction portion thus formed into the slot; and heating the entire insulator so as to heat-induced foam the portion of the foam layer other than the foaming-function reduction portion, thereby forming a foaming-function portion (for example, the foaming-function portion Fa described later) that fills the gap between the slot and the conductor.

According to (5), a foaming-function reduction portion can be formed in the foam layer by locally heat-induced foaming the foam layer provided in the insulator and then pressurizing the foamed portion, and a foaming-function portion that fills a gap between the slot and the conductor can be formed by heating the entire insulator. Thus, it is possible to easily and economically manufacture a stator including an insulator locally including a region through which a coolant can flow.
(6) The method for manufacturing a stator as described in (5), the method further including: forming a normal shape portion (for example, the normal shape portions 8N, 81N, and 82N described later) and a specific shape portion (for example, the specific shape portions 8S, 81S, and 82S described later) in a region of the conductor that is inserted into the slot, the specific shape portion having a conductor width that is partially thinner than that of the normal shape portion along a circumferential direction of the stator core, and allowing the coolant to flow in a radial direction of the stator core; and forming the foaming-function reduction portion of the insulator such that the foaming-function reduction portion of the insulator is disposed in a region corresponding to the specific shape portion of the conductor.

According to (6), the coolant can smoothly flow along the crushed portion of the conductor in the slot, and the cooling performance of the conductor is improved, so that the stator can be manufactured easily and economically.
(7) In the method for manufacturing a stator as described in (5) or (6), the slot includes a slit (for example, the slit 71 described later) that opens toward a central axial hole (for example, the central axial hole 61 described later) of the stator core, and the foaming-function portion of the insulator is formed so as to be disposed in the slit.

According to (7), it is possible to easily and economically manufacture a stator capable of effectively preventing the coolant that has flowed into the slot from leaking through the slit.

According to the present disclosure, it is possible to provide a stator including an insulator that allows coolant to flow between a conductor and a slot and that can be easily and economically manufactured, a rotating electric machine including such a stator, and a method for manufacturing such a stator.

### BRIEF DESCRIPTION OF THE DRAWINGS

FIG. 1 is a conceptual diagram of a coolant circulation mechanism in a rotating electric machine according to one example of the present disclosure;

FIG. 2 is a schematic diagram illustrating one example of a coolant flow path from a stator core to a conductor in the rotating electric machine illustrated in FIG. 1;

FIG. 3 is a schematic diagram illustrating another example of a coolant flow path from a stator core to a conductor in the rotating electric machine illustrated in FIG. 1;

FIG. 4A is a diagram illustrating one step in an example of a method for manufacturing a conductor applied to the rotating electric machine illustrated in FIG. 1;

FIG. 4B is a diagram illustrating a subsequent step in the example of the method for manufacturing a conductor applied to the rotating electric machine illustrated in FIG. 1;

FIG. 4C is a diagram illustrating a further subsequent step in the example of the method for manufacturing a conductor applied to the rotating electric machine illustrated in FIG. 1;

FIG. 5 is a schematic diagram illustrating a coolant flow path in a rectangular region IS illustrated in FIGS. 2 and 3;

FIG. 6 is a schematic diagram illustrating a cross-sectional view taken along the line A-A of the coolant flow path illustrated in FIG. 5;

FIG. 7 is a schematic diagram illustrating a cross-sectional view taken along the line B-B of the coolant flow path illustrated in FIG. 5;

FIG. 8 is a perspective view illustrating a stator of another example of a rotating electric machine according to the present disclosure;

FIG. 9 is a schematic diagram illustrating one example of a coolant flow path inside a slot of the stator illustrated in FIG. 8;

FIG. 10 is a schematic diagram illustrating a coolant flow path in the rectangular region IS illustrated in FIG. 9;

FIG. 11 is a schematic diagram illustrating a cross-sectional view taken along the line A-A of the coolant flow path illustrated in FIG. 10;

FIG. 12 is a schematic diagram illustrating a cross-sectional view taken along the line B-B of the coolant flow path illustrated in FIG. 10;

FIG. 13 is a diagram illustrating another example of a conductor arranged in a slot of the rotating electric machine illustrated in FIGS. 1 and 8;

FIG. 14 is a diagram illustrating yet another example of a conductor arranged in a slot of the rotating electric machine illustrated in FIGS. 1 and 8;

FIG. 15A is a diagram illustrating one step in another example of a method for manufacturing a conductor applied to the rotating electric machine illustrated in FIGS. 1 and 8;

FIG. 15B is a diagram illustrating a subsequent step in another example of a method for manufacturing a conductor applied to the rotating electric machine illustrated in FIGS. 1 and 8;

FIG. 15C is a diagram illustrating a further subsequent step in another example of a method for manufacturing a conductor applied to the rotating electric machine illustrated in FIGS. 1 and 8;

FIG. 16 is a perspective view illustrating one example of a configuration around the coolant flow path illustrated in FIGS. 5 to 7;

FIG. 17 is a conceptual diagram illustrating an extracted portion of the coolant flow path illustrated in FIG. 16;

FIG. 18 is a perspective view illustrating another example of a configuration around the coolant flow path illustrated in FIGS. 5 to 7;

FIG. 19 is a conceptual diagram illustrating an extracted portion of the coolant flow path illustrated in FIG. 18;

FIG. 20 is a perspective view illustrating yet another example of a configuration around the coolant flow path illustrated in FIGS. 5 to 7;

FIG. 21 is a conceptual diagram illustrating an extracted portion of the coolant flow path illustrated in FIG. 20;

FIG. 22 is a cross-sectional view of an insulator used in the rotating electric machine according to the present embodiment;

FIG. 23 is a front view illustrating an unfolded state of the insulator of the rotating electric machine according to the present embodiment;

FIG. 24 is a longitudinal sectional schematic diagram illustrating a slot of a stator in which the insulator and the conductor illustrated in FIG. 23 are accommodated;

FIG. 25 is a schematic diagram illustrating a cross-sectional view taken along the line C-C of the slot illustrated in FIG. 24;

FIG. 26 is a schematic diagram illustrating an enlarged view illustrating the relationship between the insulator and the crushed portion of the conductor in the slot illustrated in FIG. 24; and

FIG. 27 is a diagram illustrating a manufacturing step of the insulator illustrated in FIG. 23.

### DETAILED DESCRIPTION OF THE INVENTION

Hereinafter, the rotating electric machine according to the present disclosure will be described with reference to the drawings. In the drawings described below, the same reference numerals are given to corresponding components. For diagrams including directional indications, “AD” represents the axial direction of the rotating electric machine and the stator, “CD” represents the circumferential direction of the rotating electric machine and the stator, and “RD” represents the radial direction of the rotating electric machine and the stator.

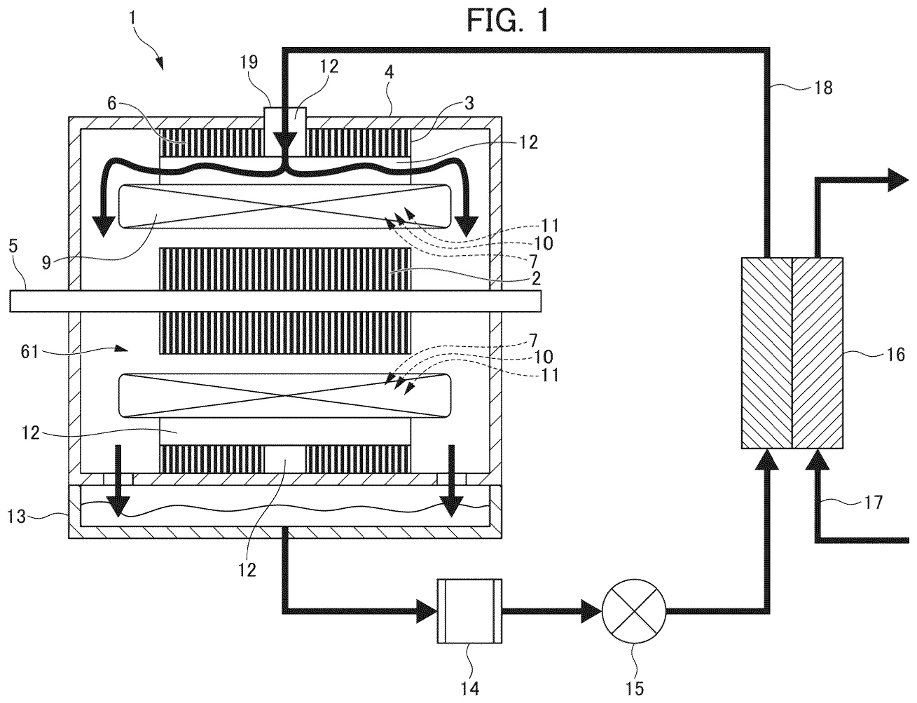

FIG. 1 is a conceptual diagram of a coolant circulation mechanism in a rotating electric machine 1 according to one example of the present disclosure. In FIG. 1, the rotating electric machine 1 is configured by including a rotor 2 and a stator 3. The rotor 2 is formed in a cylindrical shape. The stator 3 is disposed around the rotor 2 with a predetermined gap therebetween. The stator 3 includes a stator core 6 having an annular cross section. The stator core 6 includes a central axial hole 61 that penetrates in the axial direction at the center.

A casing 4 that constitutes an outer shell of the rotating electric machine 1 is provided in contact with an outer periphery of the stator 3. A rotating shaft 5 penetrates the rotational center of the rotor 2. The rotating shaft 5 is supported at both axial end portions of the casing 4 by bearings (not illustrated).

In the stator core 6 of the stator 3, a plurality of slots 7 are arranged at equal intervals in the circumferential direction. Each slot 7 includes a slit 71 that opens toward the central axial hole 61 of the stator core 6. The slits 71 are formed along the axial direction of the stator core 6. A plurality of conductors 8 are arranged in each of the plurality of slots 7 of the stator core 6. Each conductor 8 is a flat rectangular conductor (rectangular conductor) having a rectangular cross section. The plurality of conductors 8 are electrically connected to form a coil 9 disposed in the stator core 6.

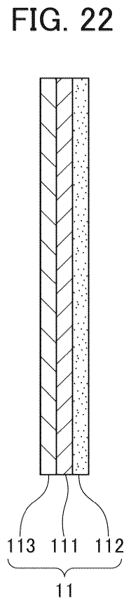

In each of the plurality of slots 7, an insulator 11 is disposed along an inner wall surface 10. As illustrated in FIG. 22, the insulator 11 includes a foam layer 112 formed on one surface of a sheet-shaped base material 111, and an adhesive layer 113 that does not foam on the other surface. Note that the adhesive layer may be formed only in corresponding portions.

The rotating electric machine 1 generates heat due to copper loss and iron loss, but the stator core 6 and the coil 9 are cooled by a coolant circulating through a coolant flow path 12 formed in the stator 3, as described later. As the coolant, for example, ATF (Automatic Transmission Fluid) may be used. Coolant stored in a coolant reservoir 13 provided in the casing 4 is supplied to the suction side of a pump 15 via a filter 14. The coolant is cooled by exchanging heat with coolant flowing through an external coolant flow path 17 by a heat exchanger 16 provided on the delivery side of the pump 15. The cooled coolant is supplied to a coolant supply port 19 of the stator core 6 via a coolant supply passage 18. The coolant supplied to the stator core 6 flows through the stator core 6 and the conductors 8 in the slots 7 via a route as will be described later, and is collected into the coolant reservoir 13 for repeated circulation.

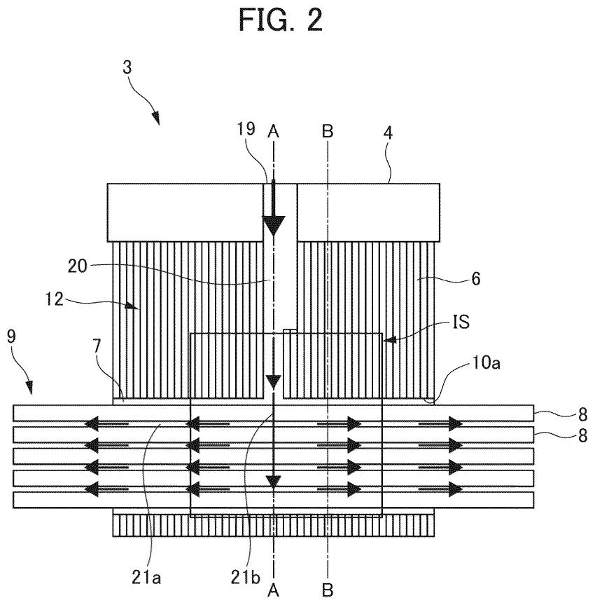

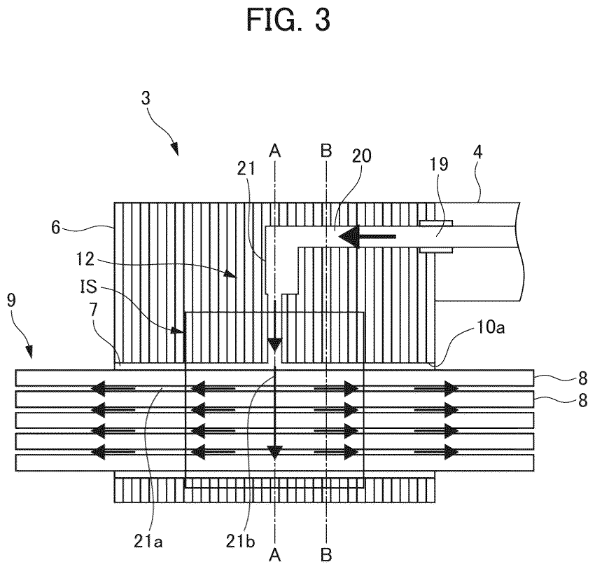

FIG. 2 is a schematic diagram illustrating one example of the coolant flow path 12 extending from the stator core 6 to the coil 9 in the slot 7 of the rotating electric machine 1 illustrated in FIG. 1. FIG. 3 is a schematic diagram illustrating another example of the coolant flow path 12 extending from the stator core 6 to the coil 9 in the rotating electric machine 1 illustrated in FIG. 1. Referring to FIG. 2, the coolant flow path 12 is configured to extend from the casing 4 side of the stator 3, through a stator-core internal coolant flow path 20 provided within the stator core 6, and to reach the coil 9 in the slot 7. Note that in the following figures, the illustration of the insulator 11 inside the slot 7 may be omitted to facilitate understanding of the coolant flow path 12.

The coolant flow path 12 in FIG. 2 includes a stator-core internal coolant flow path 20 provided inside the stator core 6. The stator-core internal coolant flow path 20 is configured to communicate a coolant supply port 19 of the casing 4 with an outer peripheral end portion of the slot 7. In the coolant flow path 12 illustrated in FIG. 2, the stator-core internal coolant flow path 20 extends straight in the radially inward direction from the coolant supply port 19 of the casing 4 to reach the outer peripheral end portion of the slot 7, and communicates with a first coolant flow path 21a described later. The first coolant flow path 21a communicates with a second coolant flow path 21b that extends along the longitudinal direction of a straight portion of the conductor 8.

Meanwhile, in the coolant flow path 12 illustrated in FIG. 3, the stator-core internal coolant flow path 20 extends in the axial direction from the coolant supply port 19 provided at a side end portion near the outer periphery of the stator core 6, turns toward the radially inward direction at an intermediate position in the thickness dimension of the stator core 6, reaches the outer peripheral end portion of the slot 7, and communicates with the first coolant flow path 21a described later. The first coolant flow path 21a communicates with the second coolant flow path 21b extending along the longitudinal direction of the straight portion of the conductor 8. In addition, the stator-core internal coolant flow path 20 illustrated in FIG. 3 also communicates with a circumferential coolant flow-communication passage 21 that is formed in the circumferential direction (perpendicular to the sheet surface of FIG. 3) at an intermediate location in the radially inward direction.

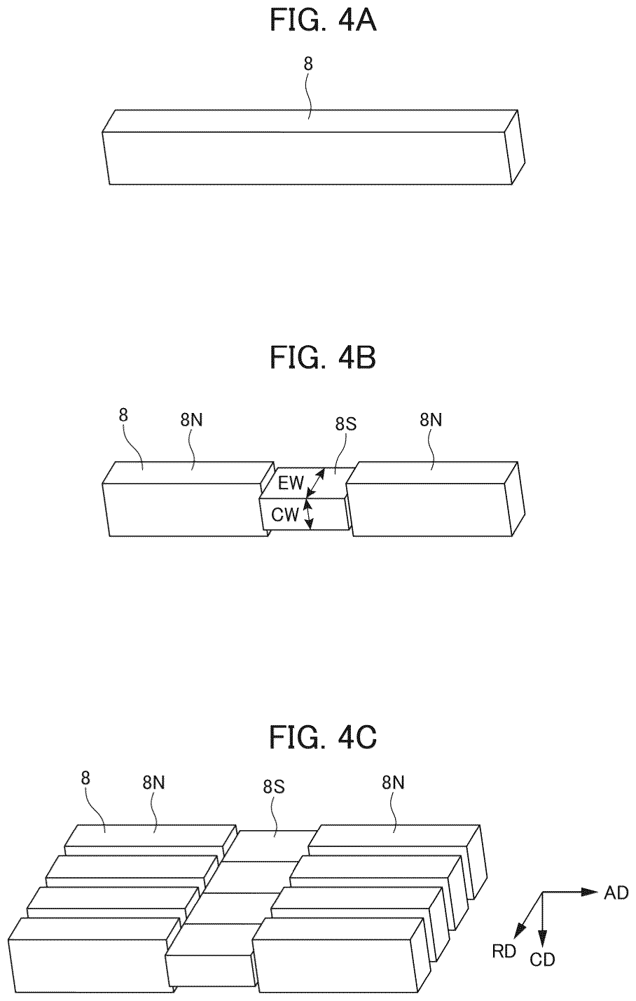

Here, the conductor 8 configuring the coil 9 will be described with reference to FIGS. 4A, 4B, and 4C. FIG. 4A is a diagram illustrating one step in an example of a method for manufacturing the conductor 8 applied to the rotating electric machine 1. FIG. 4B is a diagram illustrating a subsequent step in the same example of a method for manufacturing the conductor 8. FIG. 4C is a diagram illustrating a further subsequent step in the same example of a method for manufacturing the conductor 8.

First, the conductor 8 illustrated in FIG. 4A is prepared. This conductor 8 has a constant rectangular cross-sectional shape throughout the entire length thereof, and the cross-sectional dimensions thereof are also constant. Similar to a typical flat rectangular conductor of this type, the conductor 8 is covered with an insulating coating.

Next, a middle region of the straight section of the conductor 8 to be arranged in the slot 7 is partially pressurized using a press machine. The direction of pressurizing the conductor 8 is along the circumferential direction of the stator core 6 when the conductor 8 is inserted into the slot 7. As a result of this pressurization, as illustrated in FIG. 4B, the middle region of the conductor 8 is partially crushed and deformed to form a specific shape portion 8S having a conductor width that is partially thinner in the circumferential direction of the stator core 6. In the specific shape portion 8S, the thickness in one direction orthogonal to the longitudinal direction of the conductor 8 is relatively small (dimension CW in FIG. 4B), and the thickness in the other direction is relatively large (dimension EW in FIG. 4B). In this case, the normal shape portion 8N, which is a part of the conductor 8 other than the specific shape portion 8S, is not crushed by the press machine and retains the original form as illustrated in FIG. 4A, i.e., a constant rectangular cross-sectional shape and constant cross-sectional dimensions throughout the entire length. Accordingly, the conductor width in the circumferential direction of the stator core 6 in the normal shape portion 8N is greater than the conductor width in the circumferential direction of the stator core 6 in the specific shape portion 8S. It should be noted that the inventors have verified that even when the conductor 8 is partially pressurized and deformed as illustrated in FIG. 4B using a press machine, the insulating coating is not damaged.

In the next step, the plurality of conductors 8 formed as illustrated in FIG. 4B are arranged in the slot 7 as illustrated in FIG. 4C such that the positions of the respective specific shape portions 8S align with each other. The respective end portions of the arranged conductors 8 (normal shape portions 8N) are electrically connected in a predetermined relationship to function as a coil 9. Since the conductors 8 do not include any special grooves along the longitudinal direction thereof, the conductors 8 are easy to manufacture. Alternatively, in the stage illustrated in FIG. 4A, a conductor 8 without an insulating coating may be used, and after being partially pressurized and deformed as illustrated in FIG. 4B using a press machine, the insulating coating may be applied (e.g., by painting) to the portions other than the weld-target regions.

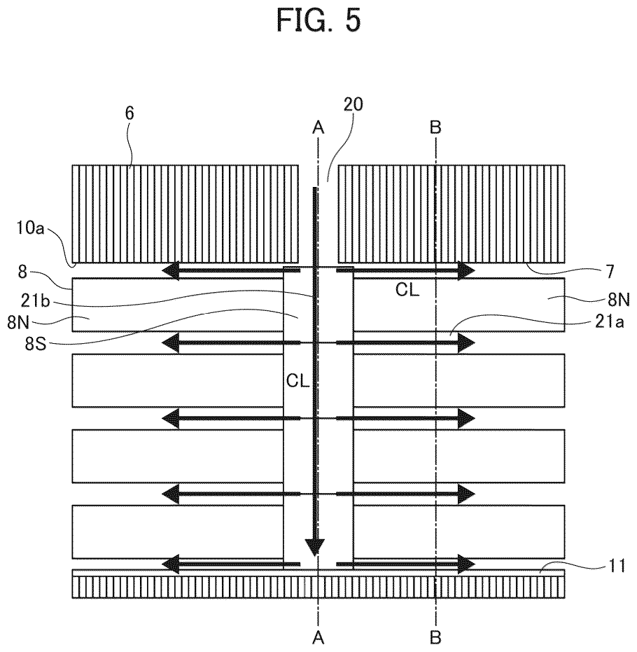

As described above, by using the conductor 8, in which the specific shape portion 8S as a crushed portion formed by partially crushing and deforming the conductor 8 is formed between normal shape portions 8N, a coolant flow path around the coil 9 is formed. Next, the coolant flow path around the coil 9 will be described with reference to FIGS. 5, 6, and 7.

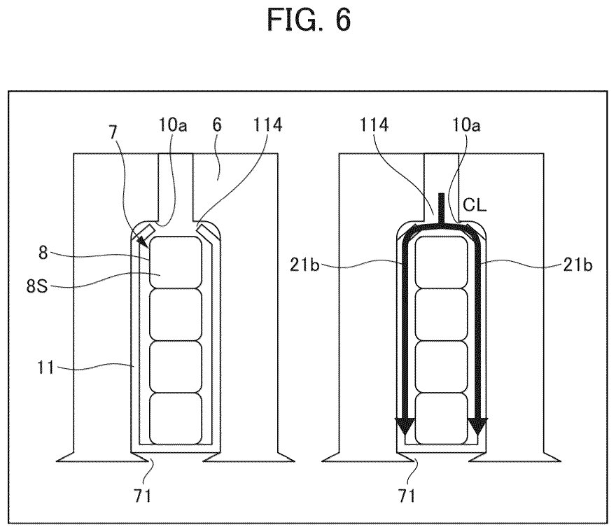

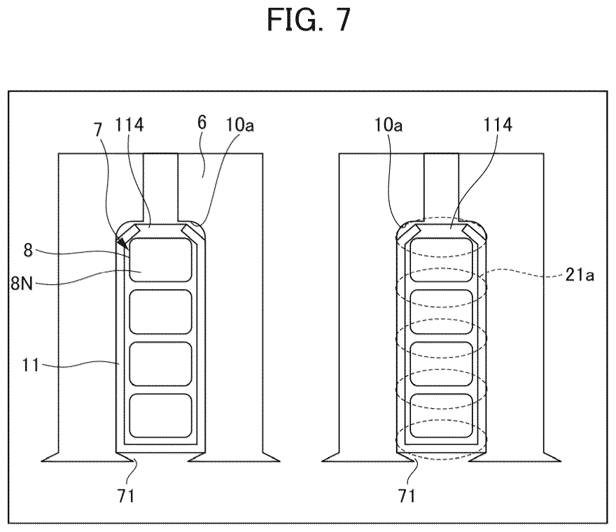

FIG. 5 is a schematic diagram illustrating a coolant flow path in a rectangular region IS illustrated in FIGS. 2 and 3. FIG. 6 is a schematic diagram illustrating a cross-sectional view taken along the line A-A of the coolant flow path illustrated in FIG. 5. FIG. 7 is a schematic diagram illustrating a cross-sectional view taken along the line B-B of the coolant flow path illustrated in FIG. 5. In the portion illustrated in FIG. 6, the specific shape portions 8S of the conductors 8 are arranged in an overlapping manner in the radial direction (the radial direction of the stator core 6) within the slot 7 without any gap therebetween.

In FIG. 6, among the dimensions CW and EW illustrated in FIG. 4B for the specific shape portion 8S, the relatively thicker dimension EW portions overlap in the radial direction within the slot 7, and the relatively thinner dimension CW portions are arranged to face in the circumferential direction of the stator core 6 (the left-right direction in FIG. 6) within the slot 7. In this state, a gap is formed between both sides of the specific shape portion 8S of each conductor 8 (both sides of the relatively thin dimension CW portion) and the inner wall of the slot 7, the gap constituting a second coolant flow path 21b. As schematically illustrated on the right side of FIG. 6, the coolant CL flows through the second coolant flow path 21b from the radially outer side toward the inner side. An opening 114 is formed in the insulator 11 inside the slot 7 at a position corresponding to a bottom wall surface 10a of the slot 7 opposite to the slit 71, so that the coolant CL flowing from the stator-core internal coolant flow path 20 into the slot 7 can flow between the conductor 8 and the insulator 11.

Meanwhile, in the portion illustrated in FIG. 7, the normal shape portions 8N of the conductors 8 are arranged in the radial direction within the slot 7 with a gap between each other. In FIG. 7, among the dimensions CW and EW illustrated in FIG. 4B for the specific shape portion 8S, the relatively thicker dimension EW portions overlap as in FIG. 6. As a result, gaps are formed between the normal shape portions 8N of the conductors 8, which are not the specific shape portions 8S. These gaps constitute the first coolant flow paths 21a. The region surrounded by the broken lines on the right side of FIG. 7 schematically illustrates the first coolant flow path 21a. The coolant CL flows in the axial direction of the stator 3 through the plurality of first coolant flow paths 21a.

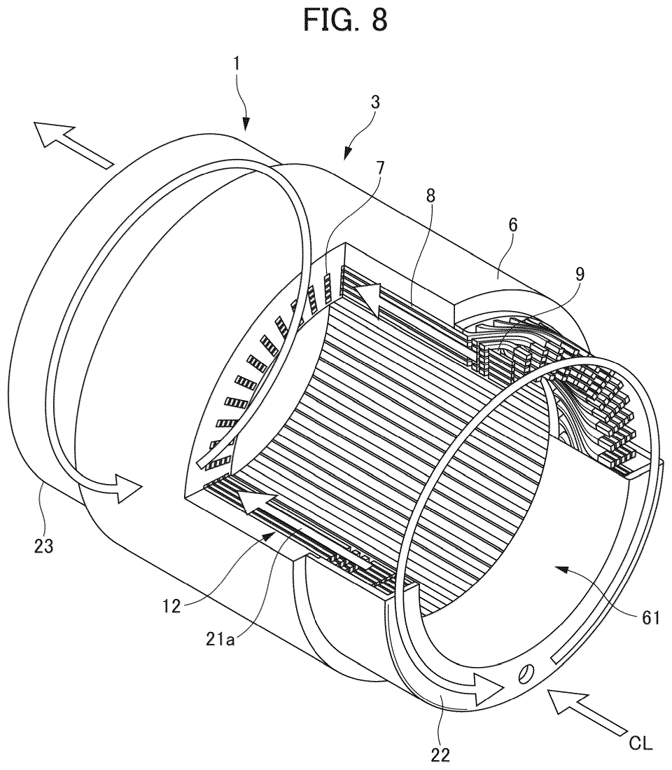

Next, another example of the rotating electric machine 1 according to the present disclosure will be described with reference to FIG. 8. FIG. 8 is a perspective view illustrating the stator 3 of another example of the rotating electric machine 1 according to the present disclosure. A plurality of slots 7 are provided at equal intervals in the circumferential direction of the stator core 6 that has an annular cross section in the rotating electric machine 1. A plurality of conductors 8 are arranged in each of the plurality of slots 7. Each conductor 8 is a flat rectangular conductor (rectangular conductor) having a rectangular cross section, and the plurality of conductors 8 are electrically connected at respective ends thereof to form a coil 9.

The conductors 8 are the same as those described with reference to FIGS. 4B and 4C. An annular front cover member 22 and an annular rear cover member 23 are attached to the front end (foreground in FIG. 8) and the rear end (background in FIG. 8) in the axial direction of the stator core 6 to cover the front and rear end portions of the coil 9. The front cover member 22 and the rear cover member 23 house the connecting conductor portions of the front and rear ends of the coil 9 and also form part of the flow path of the coolant CL. That is, the coolant flow path 12 is configured such that the coolant CL introduced into the front cover member 22 circulates annularly inside the front cover member 22, flows to the rear cover member 23 through the first coolant flow paths 21a (partly through the second coolant flow paths 21b) formed between the conductors 8 in the slots 7, and circulates through a coolant circulation path (not illustrated).

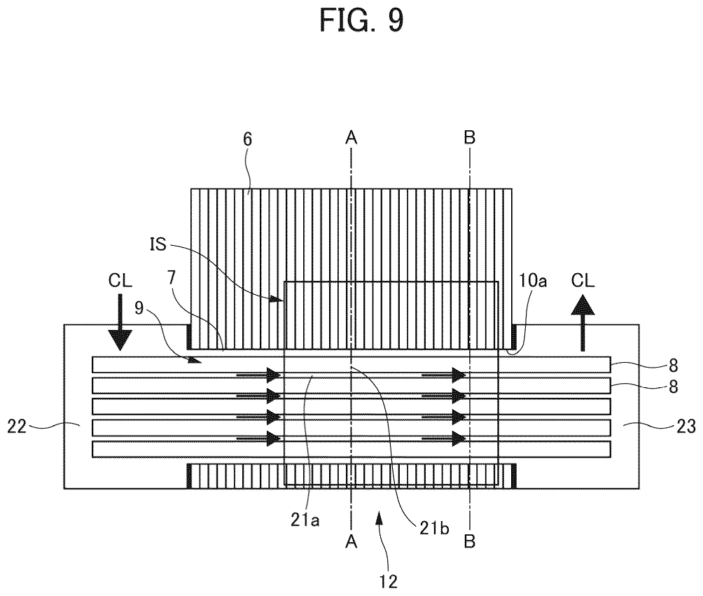

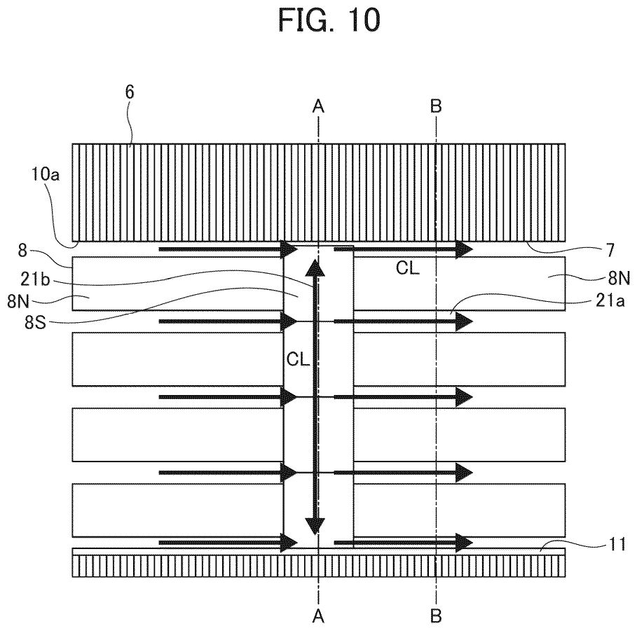

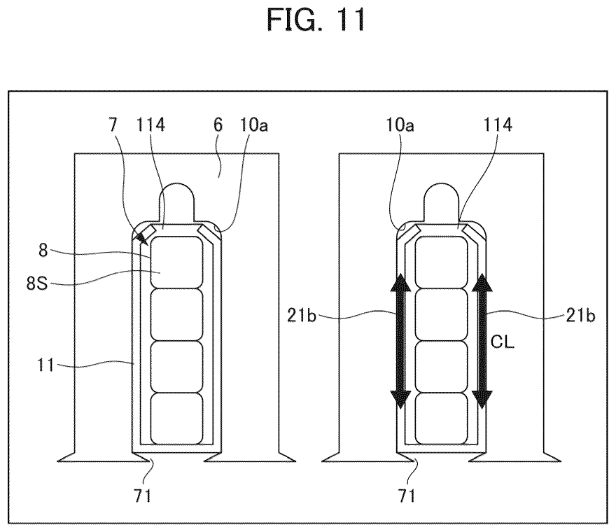

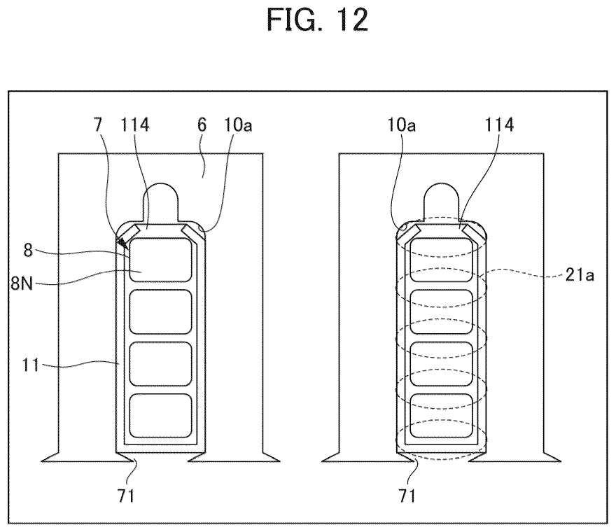

FIG. 9 is a schematic diagram illustrating one example of the coolant flow path 12 inside the slot 7 in the rotating electric machine 1 illustrated in FIG. 8. FIG. 10 is a schematic diagram illustrating a coolant flow path in a rectangular region IS illustrated in FIG. 9. FIG. 11 is a schematic diagram illustrating a cross-sectional view taken along the line A-A of the coolant flow path illustrated in FIG. 10. FIG. 12 is a schematic diagram illustrating a cross-sectional view taken along the line B-B of the coolant flow path illustrated in FIG. 10. In the coolant flow path 12 of FIG. 9, the coolant CL introduced into the front cover member 22 flows through the first coolant flow paths 21a, which are formed by the gaps between the conductors 8 (the normal shape portions 8N of the conductors 8) (partially through the second coolant flow paths 21b between both sides of the conductor 8 and the inner wall of the slot 7), reaches the rear cover member 23, and returns to a circulation path (not illustrated).

In FIGS. 10, 11, and 12, the formation of the first coolant flow paths 21a and the second coolant flow paths 21b, as well as the flow configuration of the coolant CL within the first coolant flow paths 21a and the second coolant flow paths 21b, are substantially the same as those described with reference to FIGS. 5, 6, and 7. Accordingly, the description of the formation of the first coolant flow paths 21a and the second coolant flow paths 21b in FIGS. 10, 11, and 12, as well as the flow configuration of the coolant CL within the first coolant flow paths 21a and the second coolant flow paths 21b, will rely on the same description provided for FIGS. 5, 6, and 7.

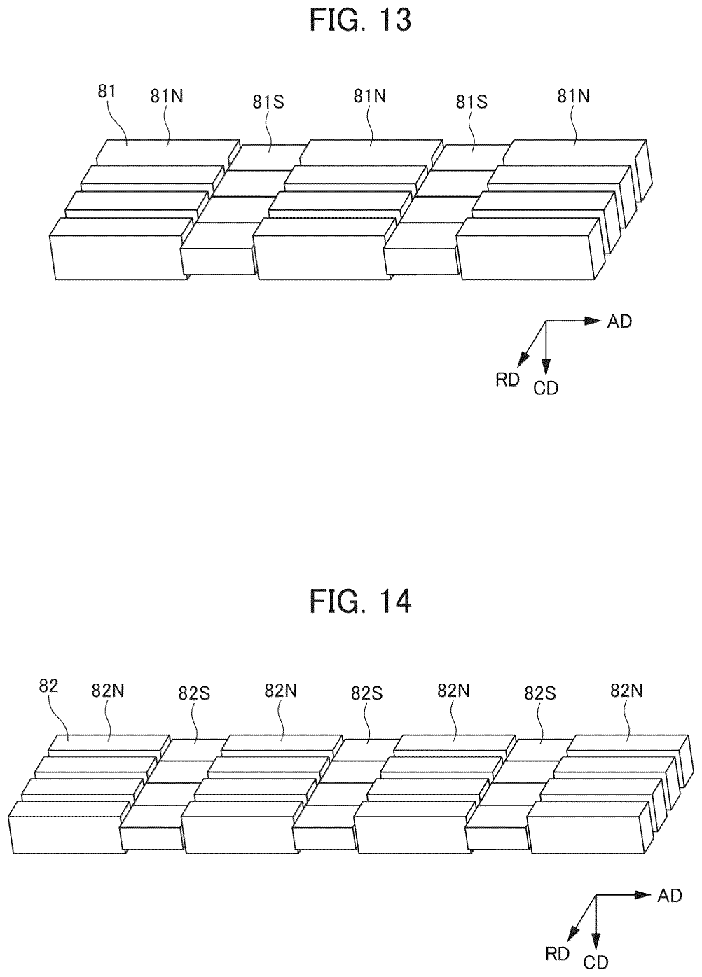

FIG. 13 is a diagram illustrating another example of a conductor arranged in a slot of the rotating electric machine illustrated in FIGS. 1 and 8. In the example illustrated in FIG. 13, the conductor 81 is a flat rectangular conductor (rectangular conductor) having a rectangular cross section and includes two specific shape portions 81S, which are crushed portions, in the straight section arranged in the slot 7 of the rotating electric machine 1. Between these two specific shape portions 81S, and at both end sides of the straight section, normal shape portions 81N are continuously formed. Each specific shape portion 81S is the same as the specific shape portion 8S described above. Each normal shape portion 81N is also the same as the normal shape portion 8N described above. By employing such a form in which the conductor 81 includes two specific shape portions 81S in the straight section thereof, two radially aligned second coolant flow paths 21b can be formed in a single slot 7. Therefore, the overall flow path resistance related to the coolant CL can be reduced, and the energy efficiency of the rotating electric machine 1 can be improved.

FIG. 14 is a diagram illustrating yet another example of conductors arranged in a slot of the rotating electric machine illustrated in FIGS. 1 and 8. In the example illustrated in FIG. 14, the conductor 82 is a flat rectangular conductor (rectangular conductor) having a rectangular cross section and includes three specific shape portions 82S, which are crushed portions, in the straight section arranged in the slot 7 of the rotating electric machine 1. Between these three specific shape portions 82S, and at both end sides of the straight section, normal shape portions 82N are continuously formed. Each specific shape portion 82S is the same as the specific shape portion 8S described above. Each normal shape portion 82N is also the same as the normal shape portion 8N described above. By employing such a form in which the conductor 82 includes three specific shape portions 82S in the straight section thereof, three radially aligned second coolant flow paths 21b can be formed in a single slot 7. Therefore, the overall flow path resistance related to the coolant CL can be reduced, and the energy efficiency of the rotating electric machine 1 can be improved.

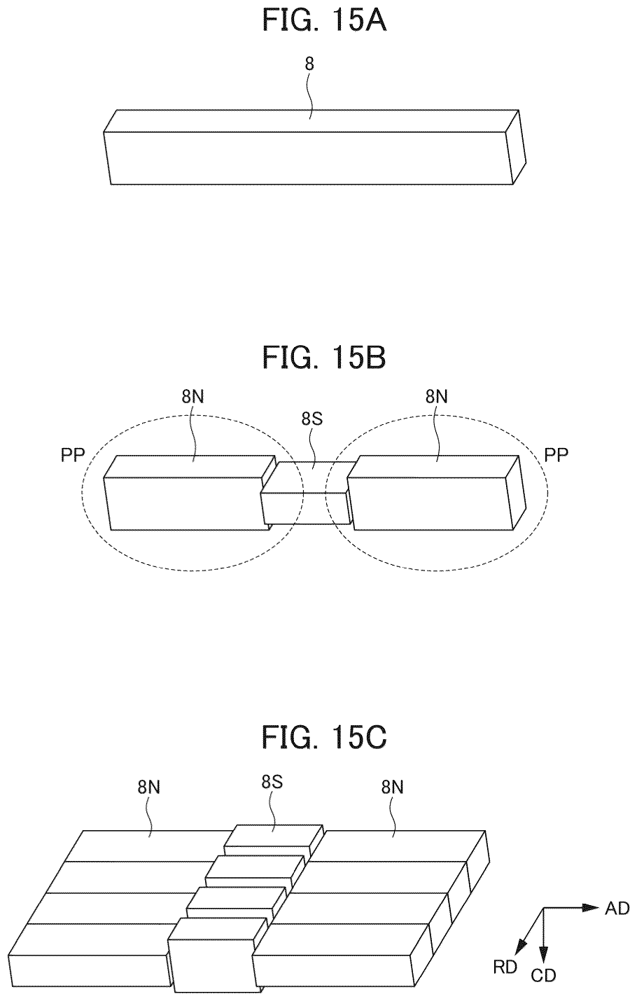

Here, another example of a method for manufacturing a conductor will be described with reference to FIGS. 15A, 15B, and 15C. FIG. 15A is a diagram illustrating one step in another example of the method for manufacturing the conductor 8 applied to the rotating electric machine 1 illustrated in FIGS. 1 and 8. FIG. 15B is a diagram illustrating a subsequent step in the other example of the method for manufacturing the conductor 8 applied to the rotating electric machine 1. FIG. 15C is a diagram illustrating a further subsequent step in the other example of the method for manufacturing the conductor 8 applied to the rotating electric machine 1.

In the manufacturing method illustrated in FIGS. 15A, 15B, and 15C, a conductor 8 is first prepared as illustrated in FIG. 15A, having a constant rectangular cross-sectional shape and constant cross-sectional dimensions throughout the entire length thereof. In this case, a conductor 8 is selected such that the aspect ratio of the long side to the short side in the rectangular cross section matches the ratio of EW to CW in the specific shape portion 8S illustrated in FIG. 4B.

Next, both end portions, excluding the intermediate region (central position) of the straight section of the conductor 8 that is to be disposed in the slot 7, are pressurized by a press machine. The direction of pressurizing the conductor 8 is the direction along the radial direction of the stator core 6 when the conductor 8 is inserted into the slot 7. In FIG. 15B, the pressurization target areas are indicated by broken-line elliptical regions PP. As a result of this pressurization, the both end portions are crushed and deformed, becoming rectangular in cross section, as illustrated in FIG. 15B, and corresponding to the normal shape portion 8N illustrated in FIG. 4A.

The specific shape portion 8S, which is not the normal shape portion 8N of the conductor 8, is not crushed by the press machine, and retains the original form thereof as illustrated in FIG. 15A, i.e., retaining a constant rectangular cross-sectional shape throughout the length thereof and retains the same short-side to long-side ratio (CW to EW) as defined for the specific shape portion 8S in FIG. 4B. As a result, the conductor width of the specific shape portion 8S in the circumferential direction of the stator core 6 becomes thinner than that of the normal shape portion 8N in the circumferential direction of the stator core 6.

In the next step, the conductors 8 formed as illustrated in FIG. 15B are arranged in the slot 7 such that the specific shape portions 8S align with each other as illustrated in FIG. 15C. Thereafter, the end portions of the arranged conductors 8 (normal shape portions 8N) are joined by welding or the like to achieve a predetermined electrical connection, thereby functioning as a coil 9. As described above, by using the conductors 8 in which the specific shape portions 8S are formed between the normal shape portions 8N, a coolant flow path around the coil 9 is formed. Since the conductors 8 do not include any special grooves along the longitudinal direction thereof, the conductors 8 are easy to manufacture.

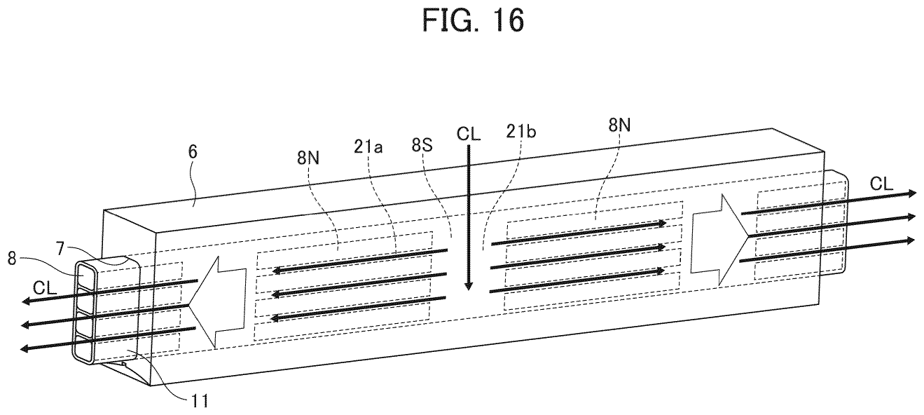

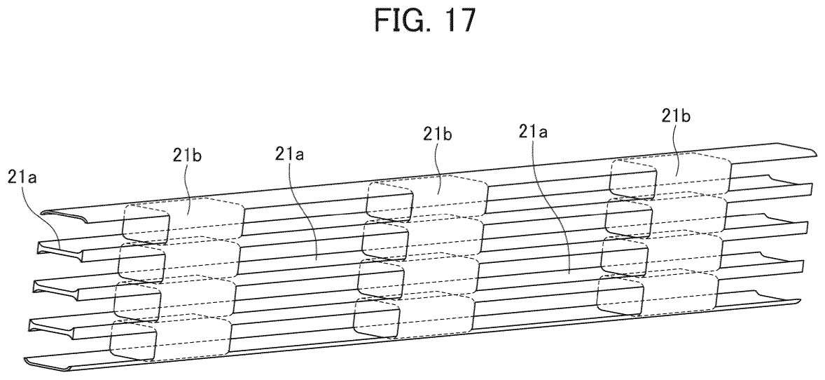

Next, an overall overview of one aspect of the coolant CL flow path in a single slot 7 of the rotating electric machine 1 according to the present disclosure will be given with reference to FIGS. 16 and 17. FIG. 16 is a perspective view illustrating one example of a configuration around the coolant flow path illustrated in FIGS. 5 to 7. FIG. 17 is a conceptual diagram illustrating an extracted portion of the coolant flow path illustrated in FIG. 16. As described in the overview with reference to FIG. 1, the coolant CL is supplied externally to an intermediate position in the axial direction of the stator core 6 of the rotating electric machine 1.

The supplied coolant CL flows radially inward through the second coolant flow paths 21b, which are formed at three positions at the intermediate portion of the slot 7 as gaps between the specific shape portions 8S of the conductors 8, which are laminated and aligned in the radial direction within the slot 7, and the inner wall of the slot 7. In the examples illustrated in FIGS. 16 and 17, three second coolant flow paths 21b are provided: one at the axial center of the slot 7 and two others spaced apart in the axial direction toward one end side and the other end side from the central position. More specifically, the second coolant flow path 21b is formed as a gap between the insulator 11, such as an insulating sheet closely adhering to the inner wall of the slot 7, and the outer surface of the conductor 8.

The coolant CL flowing through the second coolant flow paths 21b flows through the first coolant flow paths 21a that communicate with the second coolant flow paths 21b. Each first coolant flow path 21a is formed along the longitudinal direction of the conductors 8 as a gap between the normal shape portions 8N of the adjacent conductors 8. The coolant CL that has flowed from the second coolant flow paths 21b into the first coolant flow paths 21a flows in the axial direction of the rotating electric machine 1 through the first coolant flow paths 21a.

The coolant CL branches and flows from the second coolant flow path 21b at the axial center toward one end side and the other end side in the axial direction within the first coolant flow paths 21a. The coolant CL flowing through the second coolant flow paths 21b and the first coolant flow paths 21a exchanges heat with the conductors 8, cooling the heat generated due to copper loss, and flows in the axial direction toward one end side and the other end side inside the slot 7, is discharged from both axial end portions of the slot 7, drops down, flows into the coolant reservoir 13 (see FIG. 1), and is collected as described above.

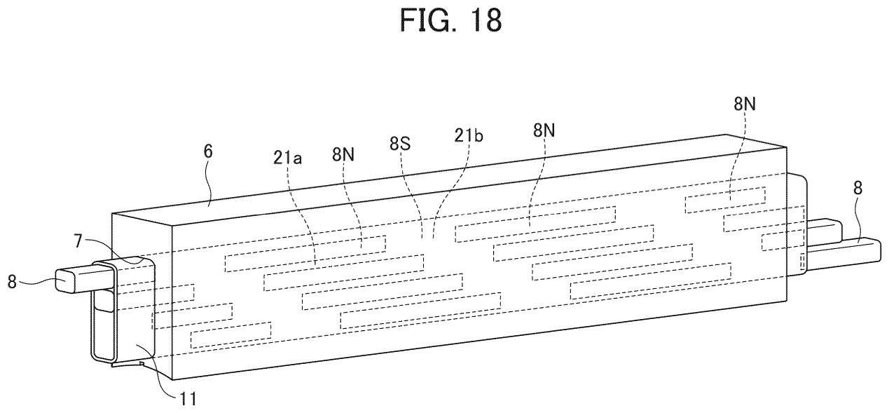

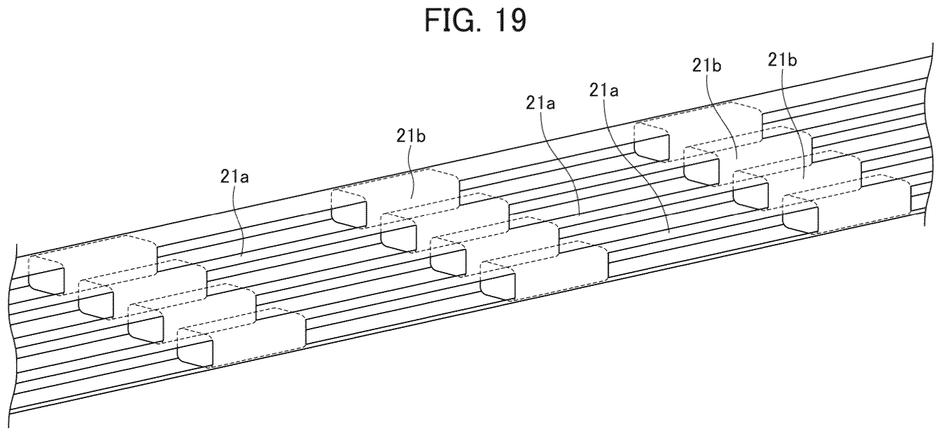

Next, an overall overview of another aspect of the coolant CL flow path in a single slot 7 of the rotating electric machine 1 according to the present disclosure will be given with reference to FIGS. 18 and 19. FIG. 18 is a perspective view illustrating another example of a configuration around the coolant flow path illustrated in FIGS. 5 to 7. FIG. 19 is a conceptual diagram illustrating an extracted portion of the coolant flow path illustrated in FIG. 18. As described in the overview with reference to FIG. 1, the coolant CL is supplied externally to an intermediate position in the axial direction of the stator core 6 of the rotating electric machine 1.

The supplied coolant CL flows radially inward through the second coolant flow paths 21b, which are formed at three positions at the intermediate portion of the slot 7 as gaps between the specific shape portions 8S of the conductors 8, which are laminated and aligned in the radial direction within the slot 7, and the inner wall of the slot 7. More specifically, the second coolant flow path 21b is formed as a gap between the insulator 11, such as an insulating sheet closely adhering to the inner wall of the slot 7, and the outer surface of the conductor 8.

In the examples illustrated in FIGS. 18 and 19, the axial phase positions of the specific shape portions 8S of the respective conductors 8 are sequentially offset in the axial direction, as the conductors are arranged radially inward from the outermost conductor 8 to the innermost conductor 8. Therefore, the second coolant flow paths 21b formed from the outer periphery toward the inner periphery within the slot 7 are inclined away from the radial direction in accordance with the axial phase shift of the specific shape portions 8S. Such second coolant flow paths 21b are provided so as to be inclined toward the inner periphery from three positions-namely, a central position in the axial direction at the outermost periphery of the slot 7, and two positions spaced apart in the axial direction toward one end side and the other end side from the central position.

The coolant CL flowing through the second coolant flow paths 21b flows through the first coolant flow paths 21a that communicate with the second coolant flow paths 21b. Each first coolant flow path 21a is formed along the longitudinal direction of the conductor 8 as a gap between the normal shape portions 8N of the adjacent conductors 8. The coolant CL that has flowed from the second coolant flow paths 21b into the first coolant flow paths 21a flows through the first coolant flow paths 21a in the axial direction of the rotating electric machine 1.

The coolant CL branches and flows from the second coolant flow path 21b at the axial center position toward one end side and the other end side in the axial direction within the first coolant flow paths 21a. The coolant CL flowing through the second coolant flow paths 21b and the first coolant flow paths 21a exchanges heat with the conductors 8, thereby cooling the heat generated by copper loss, flows through the slot 7 toward one axial end side and the other axial end side, is discharged from both axial end portions of the slot 7, drips downward, flows into the coolant reservoir 13 (see FIG. 1), and is collected as described above.

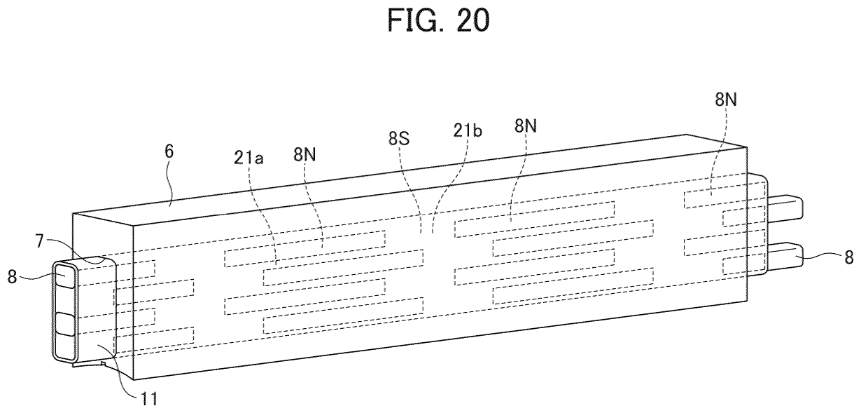

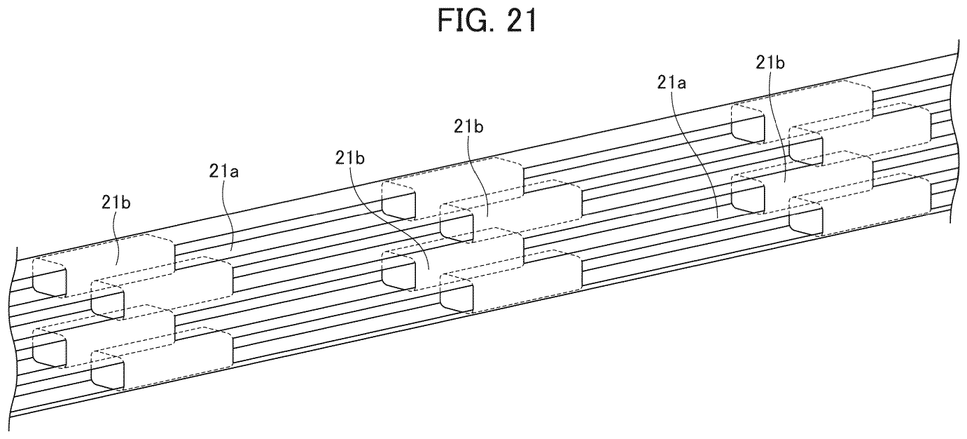

Next, an overall overview of yet another aspect of the coolant CL flow path in a single slot 7 of the rotating electric machine 1 according to the present disclosure will be given with reference to FIGS. 20 and 21. FIG. 20 is a perspective view illustrating yet another example of a configuration around the coolant flow path illustrated in FIGS. 5 to 7. FIG. 21 is a conceptual diagram illustrating an extracted portion of the coolant flow path illustrated in FIG. 20. As described in the overview with reference to FIG. 1, the coolant CL is supplied externally to an intermediate position in the axial direction of the stator core 6 of the rotating electric machine 1.

The supplied coolant CL flows radially inward through the second coolant flow paths 21b, which are formed at three positions at the intermediate portion of the slot 7 as gaps between the specific shape portions 8S of the conductors 8, which are laminated and aligned in the radial direction within the slot 7, and the inner wall of the slot 7. More specifically, the second coolant flow path 21b is formed as a gap between the insulator 11, such as an insulating sheet closely adhering to the inner wall of the slot 7, and the outer surface of the conductor 8.

In the examples illustrated in FIGS. 20 and 21, the axial phase positions of the specific shape portions 8S of the conductors 8 are arranged so as to shift in one direction and then return in the opposite direction, and again shift in one direction in a zigzag manner, as the conductors 8 are arranged from the outermost conductor 8 toward the innermost conductor 8 in the radial direction. Accordingly, the second coolant flow paths 21b formed from the outer periphery to the inner periphery within the slot 7 take a zigzag form corresponding to the axial phase shift of the specific shape portions 8S. Such second coolant flow paths 21b are provided in a zigzag manner toward the inner periphery from three positions: a central position in the axial direction at the outermost periphery of the slot 7, and two positions spaced apart in the axial direction from the central position toward one end side and the other end side in the axial direction.

The coolant CL flowing through the second coolant flow paths 21b flows through the first coolant flow paths 21a that communicate with the second coolant flow paths 21b. Each first coolant flow path 21a is formed along the longitudinal direction of the conductor 8 as a gap between the normal shape portions 8N of the adjacent conductors 8. The coolant CL that has flowed from the second coolant flow paths 21b into the first coolant flow paths 21a flows through the first coolant flow paths 21a in the axial direction of the rotating electric machine 1.

The coolant CL branches and flows from the second coolant flow path 21b at the axial center position toward one end side and the other end side in the axial direction within the first coolant flow paths 21a. The coolant CL flowing through the second coolant flow paths 21b and the first coolant flow paths 21a exchanges heat with the conductor 8, thereby cooling the heat generated by copper loss, flows inside the slot 7 in the axial direction toward one end side and the other end side, is discharged from both axial end portions of the slot 7, drips down, flows into the coolant reservoir 13 (see FIG. 1), and is collected as described above.

Next, with reference to FIGS. 22 to 26, the insulator 11 used in the stator 3, in which the above-described conductors 8, 81, or 82 are inserted in the slot 7, will be described. As illustrated in FIG. 22, the insulator 11 includes a foam layer 112 formed on one surface of a sheet-shaped base material 111, and an adhesive layer 113 that does not foam on the other surface. The insulator 11 is inserted into each slot 7 together with the conductors 8, 81, or 82, and is disposed between the inner wall surface 10 of the slot 7 and the conductors 8, 81, or 82.

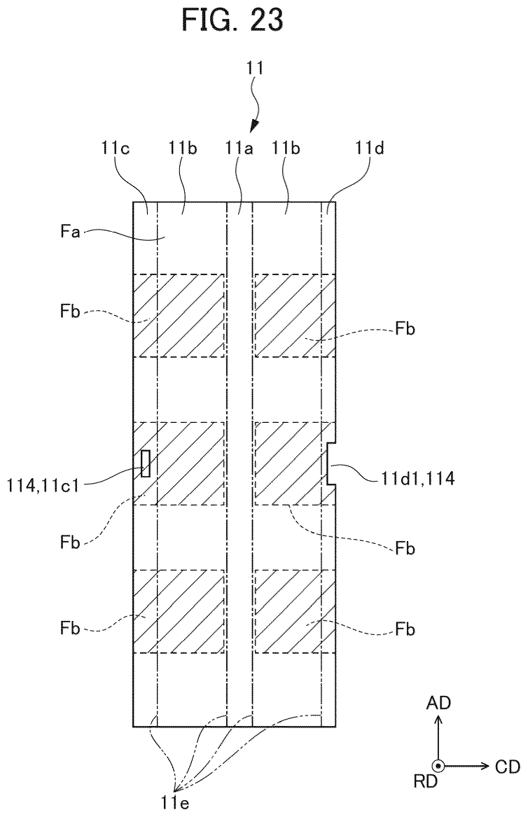

FIG. 23 illustrates the state a flat unfolded state of a single insulator 11. The insulator 11 includes a slit-shielding portion 11a, radial housing portions 11b, 11b, and fold-back portions 11c, 11d.

The slit-shielding portion 11a is disposed at the center in the width direction of the unfolded insulator 11 and is formed along the entire height direction of the insulator 11. The width direction of the unfolded insulator 11 corresponds to the circumferential direction of the stator core 6 inside the slot 7. The height direction of the insulator 11 corresponds to the axial direction of the stator core 6 inside the slot 7. The slit-shielding portion 11a is disposed so as to close the entire slit 71 from within the slot 7 when the insulator 11 is housed in the slot 7.

The radial housing portions 11b, 11b are formed continuously on both sides of the slit-shielding portion 11a. The radial housing portions 11b, 11b are disposed so as to cover the entire radial extent of the inner wall surface 10 of the slot 7 when the insulator 11 is housed in the slot 7.

The fold-back portions 11c and 11d are formed continuously on both sides of the radial housing portions 11b, 11b. The fold-back portions 11c and 11d are disposed along the bottom wall surface 10a of the slot 7 when the insulator 11 is housed in the slot 7. The fold-back portion 11c includes a rectangular opening 11c1 formed near the central region in the height direction of the insulator 11. The fold-back portion 11d includes a notch 11d1 formed by cutting a rectangular portion from the edge of the fold-back portion 11d at a position approximately in the center of the height direction of the insulator 11.

As illustrated in FIG. 23 by the two-dot chain lines, the insulator 11 includes mountain fold lines 11e formed in the height direction of the insulator 11 between the slit-shielding portion 11a and the radial housing portions 11b, 11b, and between the radial housing portions 11b, 11b and the fold-back portions 11c, 11d. The mountain fold lines 11e are virtual lines set on the insulator 11. The insulator 11 is folded along these mountain fold lines 11e, thereby being formed into a substantially rectangular shape that conforms to the inner surface shape of the slot 7 and allows for internally arranging the plurality of conductors 8, 81, or 82 along the radial direction of the stator core 6. After the insulator 11 is folded, the folded-back portions 11c and 11d overlap with each other, and the opening 11c1 and the notch 11d1 also overlap with each other, thereby forming an opening 114 that allows the coolant CL to flow into the inside of the insulator 11.

After the insulator 11 is arranged in the slot 7 together with the conductors 8, 81, or 82, the stator core 6 is heated. As a result, the foam layer 112 of the insulator 11 expands by a heat-induced foaming function and fills the gap between the conductors 8, 81, or 82 and the inner wall surface 10 of the slot 7. In a case where the adhesive layer 113 of the insulator 11 is arranged to face the conductors 8, 81, or 82, the insulator adheres to the conductors 8, 81, or 82 by heating. In a case where the adhesive layer 113 is arranged to face the inner wall surface 10 of the slot 7, the insulator adheres to the inner wall surface 10 by heating. In either case, the insulator 11 fixes the conductors 8, 81, or 82 inside the slot 7, thereby fixing the coil 9 to the stator core 6.

Here, the insulator 11 includes, in addition to the foaming-function portion Fa that exhibits the heat-induced foaming function as usual when heated inside the slot 7, the foaming-function reduction portion Fb that does not exhibit the heat-induced foaming function or exhibit the heat-induced foaming function to a lesser extent compared to the foaming-function portion Fa with a reduced heat-induced foaming function compared to the foaming-function portion Fa, so as not to obstruct the flow of coolant CL in the second coolant flow path 21b formed between the insulator 11 and the specific shape portions 8S, 81S, or 82S of the conductors 8, 81, or 82.

The insulator 11 illustrated in FIG. 23 is an example applicable in the case where the conductor 82 including three specific shape portions 82S is inserted into the slot 7. In FIG. 23, the regions of the foaming-function reduction portions Fb are indicated by hatching. All regions of the insulator 11 that are not hatched correspond to the foaming-function portions Fa. In the case of other conductors 8 or 81, the configuration of the insulator 11 illustrated in FIG. 23 is similarly applicable, except that the number and positions of the foaming-function reduction portions Fb differ depending on the number and positions of the specific shape portions 81S or 82S of the conductors 8 or 81.

In the insulator 11, the foaming-function portions Fa are formed throughout the slit-shielding portion 11a, and at four positions each in the radial housing portions 11b, 11b and the fold-back portions 11c, 11d. In the radial housing portions 11b, 11b and fold-back portions 11c, 11d, the four foaming-function portions Fa are composed of two foaming-function portions Fa, Fa formed at both heightwise ends of the insulator 11 and two foaming-function portions Fa, Fa arranged therebetween. The foaming-function portions Fa formed in the radial housing portions 11b, 11b and the fold-back portions 11c, 11d are continuous in the width direction of the unfolded insulator 11 via the foaming-function portion Fa of the slit-shielding portion 11a.

In the insulator 11, three foaming-function reduction portions Fb are formed in each of the radial housing portions 11b, 11b, and the fold-back portions 11c, 11d. These three foaming-function reduction portions Fb in the radial housing portions 11b, 11b and the fold-back portions 11c, 11d are arranged between adjacent foaming-function portions Fa, Fa in the height direction of the insulator 11. The foaming-function reduction portions Fb are not formed in the slit-shielding portion 11a, and therefore are not continuous in the width direction of the unfolded insulator 11. Therefore, six foaming-function reduction portions Fb are independently arranged in the insulator 11. The opening 11c1 and the notch 11d1 in the fold-back portions 11c, 11d are located within the area of the two foaming-function reduction portions Fb, Fb arranged in the central region of the height direction of the insulator 11.

The foaming-function portions Fa of the insulator 11 are the regions where the foam layer 112 expands by the heat-induced foaming function as usual when the stator core 6 is heated after the conductor 82 and the insulator 11 are inserted into the slot 7. These regions fill the gaps between the conductor 82 and the inner wall surface 10 of the slot 7. On the other hand, the foaming-function reduction portions Fb of the insulator 11 are the regions where the heat-induced foaming function of the foam layer 112 is reduced compared to the foaming-function portions Fa. The foaming-function reduction portions Fb are regions that do not exhibit the heat-induced foaming function of the foam layer 112 at all, or exhibit the heat-induced foaming function to a lesser extent compared to the foaming-function portions Fa when the stator core 6 is heated. Therefore, the thickness of the foaming-function reduction portions Fb of the insulator 11 after heating the stator core 6 is formed to be thinner than that of the foaming-function portions Fa.

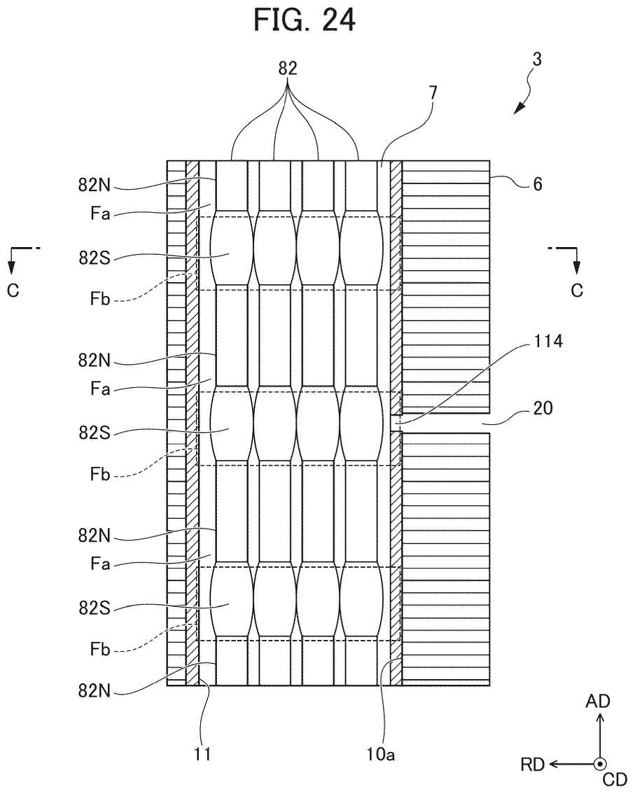

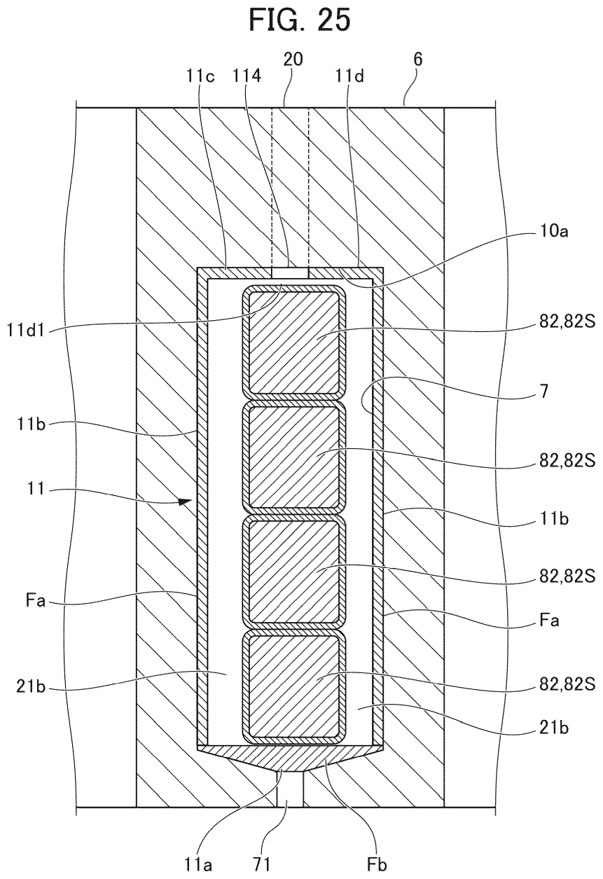

FIGS. 24 and 25 illustrate a case where four conductors 82 and the insulator 11 are inserted into the slot 7. In FIG. 24, only the region of the foaming-function reduction portion Fb is illustrated as a rectangular region enclosed by dashed lines. The opening 114 formed in the insulator 11 is arranged so as to communicate with the stator-core internal coolant flow path 20 formed in the stator core 6.

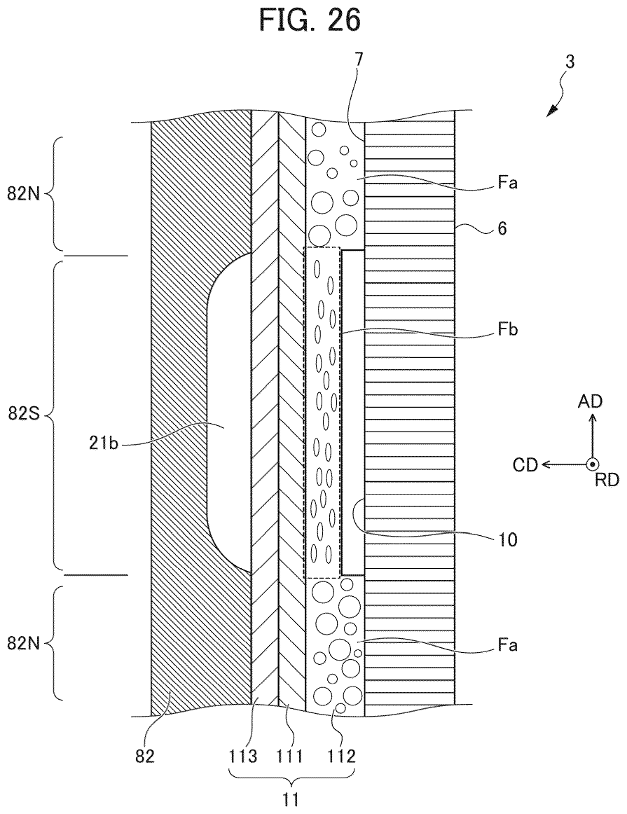

As illustrated in FIGS. 24 and 26, the foaming-function portions Fa of the insulator 11 are arranged to correspond to the regions where the normal shape portions 82N of the conductor 82 are arranged, and the foaming-function reduction portions Fb of the insulator 11 are arranged to correspond to the regions where the specific shape portions 82S of the conductor 82 are arranged. When the stator core 6 is heated, the foaming-function portions Fa of the insulator 11 exhibit the heat-induced foaming function as usual and expand to fill the gaps between the normal shape portions 82N of the conductor 82 and the inner wall surface 10 of the slot 7.

In contrast, as illustrated in FIGS. 25 and 26, when the stator core 6 is heated, the foaming-function reduction portions Fb of the insulator 11 either do not exhibit the heat-induced foaming function or exhibit the heat-induced foaming function to a lesser extent than the foaming-function portions Fa. Therefore, the foaming-function reduction portions Fb do not fill the gaps between the specific shape portions 82S of the conductor 82 and the inner wall surface 10 of the slot 7 unlike the case of the foaming-function portions Fa. As a result, the second coolant flow path 21b formed between the specific shape portions 82S of the conductor 82 and the inner wall surface 10 of the slot 7 is not closed by the foam layer 112, and the flow of the coolant CL in the second coolant flow path 21b is ensured.

As illustrated in FIG. 26, the insulator 11 is arranged in the slot 7 such that the foam layer 112 faces the inner wall surface 10 of the slot 7 and the adhesive layer 113 faces the conductor 82. Even in this arrangement, since the foaming-function reduction portion Fb is formed in the region of the foam layer 112 corresponding to the specific shape portion 82S of the conductor 82, the foaming-function reduction portion Fb does not push the base material 111 and the adhesive layer 113 of the insulator 11 toward the conductor 82 side. Therefore, the second coolant flow path 21b is appropriately ensured in the specific shape portion 82S of the conductor 82. Alternatively, the insulator 11 may be arranged in the slot 7 such that the foam layer 112 faces the conductor 82 and the adhesive layer 113 faces the inner wall surface 10 of the slot 7.

As illustrated in FIG. 25, the slit-shielding portion 11a of the insulator 11 is arranged on the slit 71 side within the slot 7 and thus blocks the slit 71 from the inside of the slot 7. As illustrated in FIG. 23, since the entire slit-shielding portion 11a includes the foaming-function portion Fa, the insulator 11, when heated inside the slot 7, substantially closes the slit 71 by foaming the foaming-function portion Fa. Therefore, there is no risk that the coolant CL flowing through the second coolant flow path 21b will leak out through the slit 71.

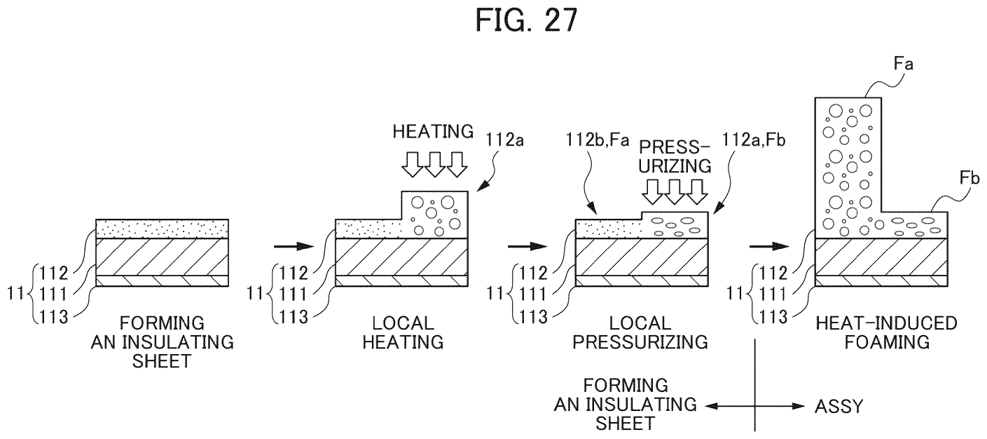

Next, a method for manufacturing the stator 3 including the insulator 11 in the slot 7 of the stator core 6 will be described with reference to FIG. 27. FIG. 27 illustrates a forming step of the insulator 11 before being arranged in the slot 7 of the stator core 6 and a forming step (ASSY) of the insulator 11 after being arranged in the slot 7 of the stator core 6.

First, a pre-heated insulator 11 is formed, including a foam layer 112 provided over the entire surface on one side of a sheet-shaped base material 111 and an adhesive layer 113 on the other side (insulator forming step). As such an insulator 11, a general insulator with a foam layer 112 formed over the entire surface on one side may be used.

Next, in the foam layer 112 of the insulator 11, local heating is applied to at least the portions where a gap is required to allow the coolant CL to flow between the specific shape portions 8S, 81S, or 82S of the conductors 8, 81, or 82, namely, the regions where the foaming-function reduction portions Fb are to be formed (local heating step). Through this local heating, the foam layer 112 locally exhibits the heat-induced foaming function, thereby forming the localized foamed portions 112a in the heated regions.

The specific method for the local heating is not particularly limited. For example, a method can be employed in which the insulator 11 is heated while the regions of the foam layer 112 to form the foaming-function portions Fa—namely, the regions that fill the gaps between the normal shape portions 8N, 81N, or 82N of the conductors 8, 81, or 82 and the inner wall surface 10 of the slot 7—are masked by a mask member having heat insulation properties. Alternatively, a method can be employed in which a selectively heatable heating element is brought into contact with the regions of the foam layer 112 of the insulator 11 where the foaming-function reduction portions Fb are to be formed, and only the contacted regions are selectively heated. The heating temperature at this stage is set such that the heated region of the foam layer 112 begins to foam by exhibiting the heat-induced foaming function of the foam layer 112, while the adhesive layer 113 has not yet developed adhesive strength.

Next, the locally foamed portion 112a, which was formed in the foam layer 112 by local heating, is forcibly crushed by applying pressurization (local pressurizing step). When the foamed portion 112a is forcibly crushed, the foamed portion 112a will no longer foam or will be less likely to foam even when reheated. As a result, the foaming-function reduction portion Fb is formed in the foam layer 112, and the unfoamed portion 112b other than the foaming-function reduction portion Fb forms the foaming-function portion Fa in the foam layer 112.

Next, the insulator 11 in which the foaming-function reduction portion Fb has been formed by forcibly crushing the foamed portion 112a is inserted, together with the conductors 8, 81, or 82, into the slot 7 of the stator core 6. Thereafter, the stator core 6 is heated to heat the insulator 11 and cause the foam layer 112 to foam (heat-induced foaming step). The heating temperature at this stage is set such that the foam layer 112 begins to foam by exhibiting the heat-induced foaming function as usual, and the adhesive layer 113 develops the adhesiveness.

At this time, the foaming-function portions Fa-namely, the regions of the foam layer 112 that were not locally heated in the local heating step and that are other than the foaming-function reduction portions Fb-exhibit the heat-induced foaming function as usual and foam, thereby filling the gaps between the conductors 8, 81, or 82 and the inner wall surface 10 of the slot 7, and fixing the conductors 8, 81, or 82 within the slot 7. On the other hand, the foaming-function reduction portions Fb, which are formed in the local pressurizing step, either do not foam or hardly foam. As a result, the thickness of the foaming-function reduction portions Fb is smaller than that of the foaming-function portions Fa. Accordingly, an appropriate gap is formed between the specific shape portions 8S, 81S, or 82S of the conductors 8, 81, or 82 and the inner wall surface of the slot 7, thereby allowing the coolant CL to flow through the second coolant flow path 21b.

According to the thus-obtained stator 3, the coolant CL can flow smoothly between the conductors 8, 81, or 82 and the slot 7, enabling the construction of a high-performance rotating electric machine 1 with excellent cooling performance. Since a general insulator in which the foam layer 112 is formed over the entire surface on one side can be used as the insulator 11 without modification, the insulator 11 can be easily and economically manufactured. Therefore, the stator 3 and the rotating electric machine 1 can be manufactured at low cost and are also excellent in economic efficiency.

### EXPLANATION OF REFERENCE NUMERALS

1: rotating electric machine
21b: second coolant flow path
3: stator
6: stator core
61: central axial hole
7: slot
71: slit
8, 81, 82: conductor
8N, 81N, 82N: normal shape portion
8S, 81S, 82S: specific shape portion
11: insulator
112: foam layer
CL: coolant
Fa: foaming-function portion
Fb: foaming-function reduction portion

What is claimed is:

1. A stator comprising:
a conductor disposed in a slot formed in a stator core; and
an insulator disposed between the slot and the conductor,
wherein the stator includes a coolant flow path that allows a coolant to flow between the slot and the conductor,
wherein the insulator includes a foam layer configured to foam when heated inside the slot, and
wherein the foam layer includes:
a foaming-function portion that fills a gap between the slot and the conductor by exhibiting a heat-induced foaming function; and
a foaming-function reduction portion that has a smaller thickness than the foaming-function portion due to a reduction in the heat-induced foaming function of the foam layer compared to the foaming-function portion, and that forms a gap between the slot and the conductor to allow the coolant to flow therethrough.

2. The stator according to claim 1,
wherein the conductor includes:
a normal shape portion in a region inserted into the slot; and
a specific shape portion that has a conductor width that is partially thinner than that of the normal shape portion along a circumferential direction of the stator core, and that allows the coolant to flow in a radial direction of the stator core,
wherein the foaming-function reduction portion of the insulator is disposed in a region corresponding to the specific shape portion of the conductor.

3. The stator according to claim 1,
wherein the slot includes a slit that opens toward a central axial hole of the stator core, and
wherein the foaming-function portion of the insulator is disposed so as to close the slit.

4. A rotating electric machine comprising the stator according to claim 1.

5. A method for manufacturing a stator including:
a conductor disposed in a slot formed in a stator core; and
an insulator disposed between the slot and the conductor,
wherein the stator includes a coolant flow path that allows a coolant to flow between the slot and the conductor,
wherein the insulator includes a foam layer configured to foam when heated inside the slot,
the method comprising:
locally heating, before inserting the insulator into the slot, a portion of the foam layer at a position where a gap allowing the coolant to flow between the conductor and the insulator is required, thereby foaming the portion of the foam layer;
pressurizing the foamed region to reduce the heat-induced foaming function, thereby forming a foaming-function reduction portion in the foam layer;
inserting the insulator including the foaming-function reduction portion thus formed into the slot; and
heating the entire insulator so as to heat-induced foam the portion of the foam layer other than the foaming-function reduction portion, thereby forming a foaming-function portion that fills the gap between the slot and the conductor.

6. The method for manufacturing a stator according to claim 5, the method further comprising:
forming a normal shape portion and a specific shape portion in a region of the conductor that is inserted into the slot, the specific shape portion having a conductor width that is partially thinner than that of the normal shape portion along a circumferential direction of the stator core, and allowing the coolant to flow in a radial direction of the stator core; and
forming the foaming-function reduction portion of the insulator such that the foaming-function reduction portion of the insulator is disposed in a region corresponding to the specific shape portion of the conductor.

7. The method for manufacturing a stator according to claim 5,
wherein the slot includes a slit that opens toward a central axial hole of the stator core, and
wherein the foaming-function portion of the insulator is formed so as to be disposed in the slit.
